(19) United States
(12) Patent Application Publication
(10) Pub. No.: US 2026/0235216 A1
(43) Pub. Date: Aug. 13, 2026

(54) REED VALVE

(71) Applicant: Moto Tassinari, Inc., West Lebanon, NH (US)

(72) Inventors: Steven M. TASSINARI, Meriden, NH (US); Calvin James COOK, Bradford, VT (US)

(21) Appl. No.: 19/535,428

(22) Filed: Feb. 10, 2026

Related U.S. Application Data
(60) Provisional application No. 63/756,955, filed on Feb. 11, 2025.

(51) Int. Cl. F16K 15/16; F16K 27/02

(52) U.S. Cl. CPC F16K 15/162; F16K 27/0227

(57) ABSTRACT

A reed valve may include a retainer, a cage coupled to the retainer, and a reed petal captured between the cage and the retainer. The cage may include an inlet, a cage body having a sealing surface that extends around an outlet, and a cage cavity fluidly coupling the inlet to the outlet. The reed petal may be elastically deformed to selectively open and close the outlet. The reed petal may be displaced from the sealing surface to open the outlet. The reed petal, the retainer, and the cage may be configured to cooperate to urge the reed petal towards the sealing surface.

### CROSS-REFERENCE TO RELATED APPLICATIONS

The present application claims the benefit of U.S. Provisional Application Serial No. 63/756,955, filed on February 11, 2025, entitled Reed Valve, which is fully incorporated herein by reference.

### TECHNICAL FIELD

The present disclosure is generally directed to one-way valves and more specifically to a reed valve for use with an engine.

### BACKGROUND INFORMATION

Reed valves are a form of check valve configured to restrict a flow of fluid (e.g., air, oil, fuel, an air-fuel mixture, an air-oil mixture, and/or an air-fuel-oil mixture) to a single direction. Reed valves include a retainer, a cage, and one or more reed petals. The cage and the retainer are configured to capture each of the reed petals such that the reed petals move between open and closed positions, allowing fluid to flow through the reed valve. Changes in pressure on the faces of each reed petal cause each reed petal to transition between the open and closed positions, opening and closing the reed valve.

Reed valves have been used in two stroke engine applications to control the fuel-air mixture into an engine cylinder. Operation of the engine (e.g., movement of the piston within the cylinder) causes a change in the intake pressures. For example, as the piston moves in a first direction, a pressure differential is created across the reed valve that causes the reed valve to open. As the piston moves in the opposite direction, the resulting pressure change causes the reed valve to close.

### BRIEF DESCRIPTION OF THE DRAWINGS

These and other features and advantages will be better understood by reading the following detailed description, taken together with the drawings, wherein:

FIG. 1 shows a schematic side view of a reed valve in a closed position, consistent with embodiments of the present disclosure.

FIG. 2 shows a schematic side view of the reed valve of FIG. 1 in an open position, consistent with embodiments of the present disclosure.

FIG. 3 shows a perspective top view of a reed valve, consistent with embodiments of the present disclosure.

FIG. 4 shows a perspective bottom view of the reed valve of FIG. 3, consistent with embodiments of the present disclosure.

FIG. 5 shows a perspective exploded view of the reed valve of FIG. 3, wherein the reed valve is exploded in a direction of assembly, consistent with embodiments of the present disclosure.

FIG. 6 shows a top perspective view of a cage of the reed valve of FIG. 3, consistent with embodiments of the present disclosure.

FIG. 7 shows a bottom perspective view of a retainer of the reed valve of FIG. 3, consistent with embodiments of the present disclosure.

FIG. 8 shows a cross-sectional view of the reed valve of FIG. 3 taken along the line VIII-VIII of FIG. 3, consistent with embodiments of the present disclosure.

FIG. 9 shows a cross-sectional view of the reed valve of FIG. 3 taken along the line IX-IX of FIG. 3, consistent with embodiments of the present disclosure.

FIG. 10 shows a schematic cross-sectional view of an example petal of the reed valve of FIG. 3, consistent with embodiments of the present disclosure.

FIG. 11 shows a cross-section view of the reed valve of FIG. 3 having a different reed petal, consistent with embodiments of the present disclosure.

FIG. 12 shows a magnified cross-sectional view of a portion of the reed valve of FIG. 11 corresponding to region XII of FIG. 11, consistent with embodiments of the present disclosure.

FIG. 13 shows a magnified cross-sectional view of a portion of another example of the reed valve of FIG. 11 that generally corresponds to the region XII of FIG. 11, consistent with embodiments of the present disclosure.

### DETAILED DESCRIPTION

The present disclosure is generally directed to a reed valve. The reed valve includes a retainer, a cage coupled to the retainer, and a reed petal captured between the cage and the retainer. In some instances, the cage, retainer, and reed petal may be configured to cooperate to impart (or preload) a spring force into the reed petal. For example, imparting of a spring force into the reed petal may encourage a more consistent engagement between the cage and the reed petal when the reed valve is in a closed position. Such a configuration may improve a sealing performance of the reed petal with the cage.

In some instances, one or more of the cage and/or the retainer may be formed as a single-piece body. For example, one or more of the cage and/or the retainer may be formed as a single-piece injection molded body. When formed via injection molding, the cage and/or retainer may be configured to minimize parting-lines, which may reduce tooling costs.

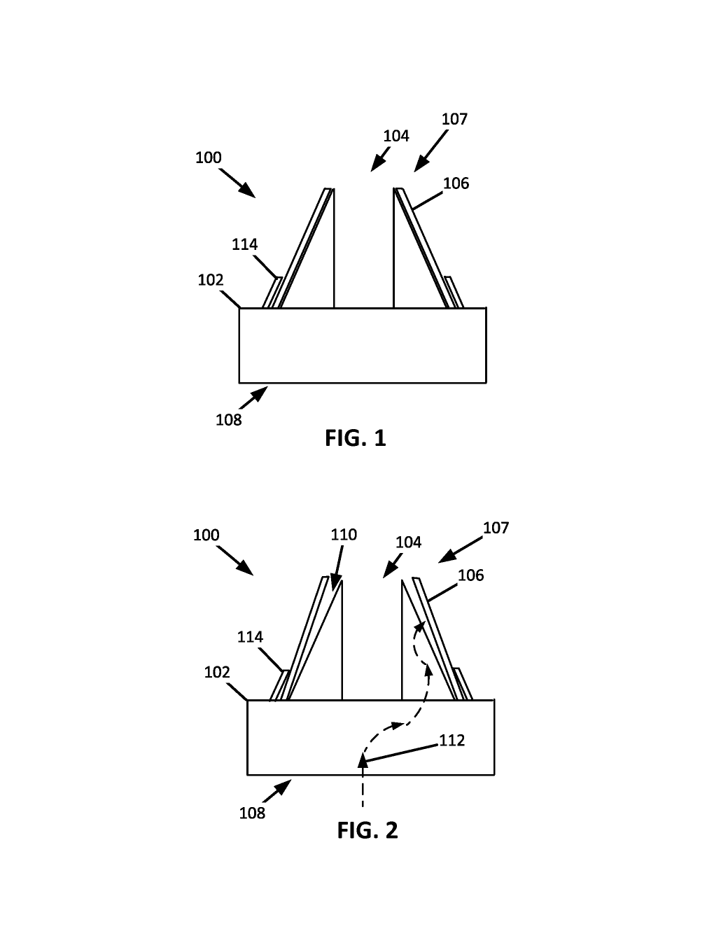

FIG. 1 shows a schematic side view of a reed valve 100 in a closed position and FIG. 2 shows a schematic side view of the reed valve 100 in an open position. As shown, the reed valve 100 includes a retainer 102, a cage 104 coupled to the retainer 102, and one or more (e.g., as shown, a plurality of) reed petals 106. The reed petals 106 are captured between the retainer 102 and the cage 104 such that the reed petals 106 can move between a closed position (FIG. 1) and an open position (FIG. 2). For example, the reed petals 106 may be constructed of a flexible material (e.g., a carbon fiber material) that is configured to elastically deform (e.g., without plastic deformation) as the reed petal 106 transitions from the closed position to the open position. As shown, when the reed petal 106 is in the open position, an opening end 107 of the reed petal 106 is displaced from the cage 104.

The reed valve 100 includes an inlet 108 that is fluidly coupled to the cage 104. For example, the cage 104 can include the inlet 108. The cage 104 includes one or more (e.g., as shown, a plurality of) outlets 110, wherein each outlet 110 is configured to be selectively covered by a corresponding reed petal 106 (e.g., each reed petal 106 is elastically deformed to selectively open and close a corresponding outlet 110). For example, and as shown, fluid (e.g., air, oil, fuel, an air-fuel mixture, an air-oil mixture, and/or an air-fuel-oil mixture) is configured to flow along a flow path 112 that extends from the inlet 108 and through each of the outlets 110. As fluid flows along the flow path 112, the fluid urges the reed petals 106 to transition to the open position. The material properties (e.g., the rigidity) of the reed petals 106 may be selected to control the pressure within the cage 104 required to cause the reed petals 106 to transition to the open position.

The retainer 102 is configured to cooperate with the cage 104 to capture the reed petals 106 therebetween. As shown, the retainer 102 includes one or more (e.g., as shown, a plurality of) reed stops 114, each reed stop 114 being configured to extend along a portion of a corresponding reed petal 106. The reed stop 114 may be configured to restrict movement of each reed petal 106.

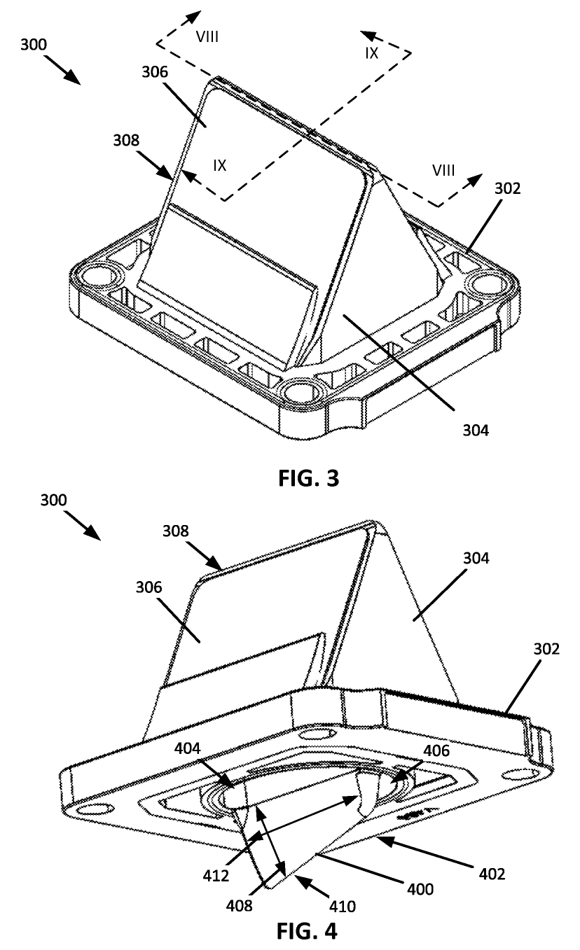

FIG. 3 is a perspective top view of a reed valve 300 and FIG. 4 is perspective bottom view of the reed valve 300. The reed valve 300 is an example of the reed valve 100 of FIG. 1.

As shown, the reed valve 300 includes a retainer 302, a cage 304, a plurality of reed petals 306, and an air guide 400 (FIG. 4). The plurality of reed petals 306 are captured between the retainer 302 and the cage 304 such that the reed petals 306 are on opposing sides of the cage 304. Each of the reed petals 306 extend over at least one outlet 308, selectively opening and closing the respective outlets 308. In some instances, when the reed petals 306 close a respective one or more outlets 308, the reed petals 306 may be elastically deformed as a result of engaging the cage 304 at the outlets 308, causing the reed petals 306 to exert a force on the cage 304 (e.g., to form a seal with the cage 304 that extends around at least a portion of the corresponding one or more outlets 308). Each of the outlets 308 are fluidly coupled to an inlet 402. The inlet 402 (FIG. 4) is divided into a first inlet portion 404 (FIG. 4) and a second inlet portion 406 (FIG. 4) by the air guide 400.

As shown, the cage 304 includes the air guide 400. The air guide 400 extends from the inlet 402 by a guide extension distance 408 (FIG. 4) and extends through the inlet 402, creating the first and second inlet portions 404 and 406. The guide extension distance 408 corresponds to a distance extending from the inlet 402 to a distal edge 410 (FIG. 4) of the air guide 400. The distal edge 410 can be tapered such that the guide extension distance 408 decreases (e.g., linearly) from a maximum extension distance to a minimum extension distance along a guide length 412 of the air guide 400, the minimum extension distance being less than the maximum extension distance. The guide length 412 extends in a direction perpendicular to the guide extension distance 408.

The guide extension distance 408 may be, for example, in a range of 4 millimeters (mm) to 20 mm. By way of further example, the guide extension distance 408 may have a maximum distance in a range of 10 mm to 20 mm that tapers to a minimum distance in a range of 3 mm to 8 mm. By way of still further example, the guide extension distance 408 may have a maximum distance in a range of about (e.g., within 15% of, 10% of, 5% of, 4% of, 3% of, 2% of, or 1% of) 16 mm that tapers to a minimum distance of about 6 mm.

The retainer 302 may be formed as a single-piece (or monolithic) body. In other words, the retainer 302 is formed without the use of coupling elements (e.g., mechanical fasteners, adhesives, and/or the like). For example, the retainer 302 may be formed through additive manufacturing processes (e.g., 3D printing), subtractive manufacturing processes (e.g., machining a single material to take the form of the retainer 302), molding (e.g., injection molding), or the like.

The cage 304 may be formed as a single-piece (or monolithic) body. In other words, the cage 304 is formed without the use of coupling elements (e.g., mechanical fasteners, adhesives, and/or the like). For example, the cage 304 may be formed through additive manufacturing processes (e.g., 3D printing), subtractive manufacturing processes (e.g., machining a single material to take the form of the cage 304), molding (e.g., injection molding), or the like.

When the retainer 302 and the cage 304 are formed using injection molding, the retainer 302 and the cage 304 may be configured to cooperate to couple together while minimizing parting lines generated as result of the injection molding process. For example, the retainer 302 and/or the cage 304 may include five or fewer parting lines, four or fewer parting lines, three or fewer parting lines, or two or fewer parting lines.

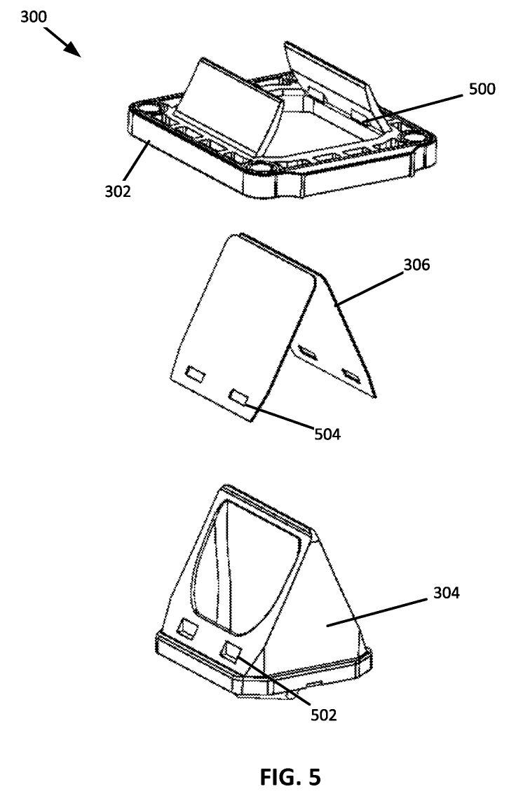

FIG. 5 shows an exploded view of the reed valve 300. The reed valve 300 is exploded in a direction of assembly. For example, each of the plurality of reed petals 306 are configured to be positioned on the cage 304 and the cage 304 with reed petals 306 thereon is configured to be inserted into the retainer 302, capturing the reed petals 306 between the cage 304 and the retainer 302. When the cage 304 is fully inserted into the retainer 302, the cage 304 is configured to couple with the retainer 302 (e.g., via a mechanical coupling such as a snap-fit).

As shown, the retainer 302 includes a plurality of petal tabs 500 and the cage 304 includes a plurality of tab receptacles 502 configured to cooperate with (e.g., receive at least a portion of) a corresponding petal tab 500 to capture a respective reed petal 306. For example, when assembled, at least a portion of each petal tab 500 extends through a corresponding petal opening 504 of a respective reed petal 306 and into a corresponding tab receptacle 502. Positioning the petal tabs 500 on the retainer 302 (e.g., instead of on the cage 304) may encourage more efficient manufacturing. For example, when the retainer 302 and the cage 304 are formed by molding (e.g., injection molding), the number of parting lines may be reduced, which may simplify the tooling, when compared to an embodiment having petal tabs on the cage 304.

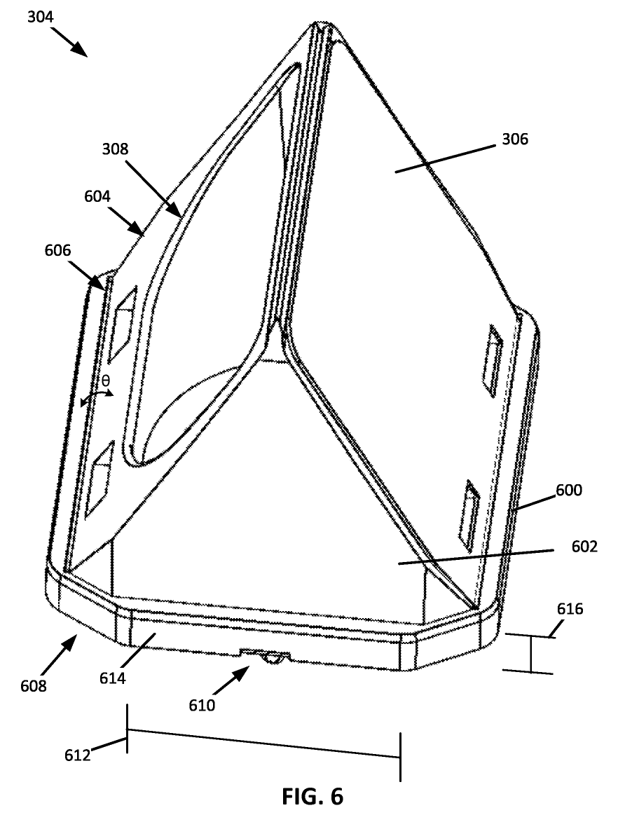

FIG. 6 shows a perspective view of the cage 304 with one of the reed petals 306 removed, exposing one of the outlets 308. As shown, the cage 304 includes a cage base 600 and a cage body 602 extending from the cage base 600. The cage body 602 includes a plurality of sealing surfaces 604 against which a corresponding reed petal 306 rests when the reed valve 300 is in the closed position. Each sealing surface 604 extends around a corresponding outlet 308. As shown, each sealing surface 604 forms a surface angle θ with the cage base 600. The surface angle θ may be an obtuse angle. In other words, the sealing surface 604 may be angled such that the cage body 602 tapers in a direction away from the cage base 600.

The cage 304 further includes a plurality of petal alignment grooves 606 that extend along each sealing surface 604. Each petal alignment groove 606 is configured to receive a portion of a corresponding reed petal 306. The petal alignment groove 606 is configured to align a respective reed petal 306 on the cage body 602. For example, each petal alignment groove 606 may be configured to encourage each reed petal 306 to remain aligned while the cage 304 is being inserted into the retainer 302 (FIG. 3). The petal alignment groove 606 may extend between the tab receptacles 502 and a cage bottom surface 608. In some instances, the petal alignment groove 606 may be configured to encourage a corresponding reed petal 306 to elastically deform when the cage 304 is coupled to the retainer 302. The elastic deformation urges the reed petals 306 into engagement with a corresponding sealing surface 604 (e.g., to form a seal with the sealing surface 604). Such a configuration may allow the tolerances of one or more portions of the cage 304 to be reduced as the reed petals 306 are urged into engagement with the sealing surface 604. Additionally, or alternatively, such a configuration may allow for the omission of a separate seal on the sealing surface 604 for forming a seal with a respective reed petal 306.

In some instances, the cage base 600 includes a notch 610 and one or more base sides 614. The notch 610 extends within at least one of the one or more base sides 614 for at least a portion of a wall length 612 of the one or more base sides 614. The notch 610 extends from the cage bottom surface 608 in a direction of the cage body 602 for a portion of a wall height 616 of the one or more base sides 614. The notch 610 may include a taper that extends inwardly.

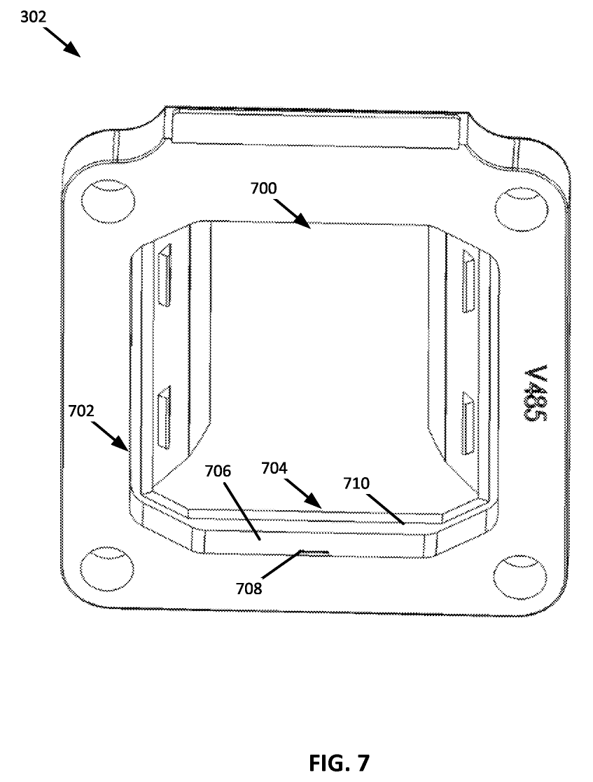

FIG. 7 shows a perspective bottom view of the retainer 302. As shown, the retainer 302 includes a retainer cavity 700. The retainer cavity 700 includes an insertion opening 702, an exit opening 704, and one or more retainer sidewalls 706 extending between the insertion opening 702 and the exit opening 704. The one or more retainer sidewalls 706 include a retainer protrusion 708 configured to cooperate with the notch 610 (FIG. 6) to couple the cage 304 (FIG. 3) with the retainer 302. As shown, the retainer protrusion 708 is disposed between the insertion and exit openings 702 and 704 and extends from the one or more retainer sidewalls 706 and into the retainer cavity 700.

As also shown, a retention shelf 710 can be disposed at the exit opening 704. The retention shelf 710 extends into the retainer cavity 700, reducing an open area of the exit opening 704 relative to the insertion opening 702. As such, the retention shelf 710 may be generally described as being configured to restrict an insertion distance of the cage 304 into the retainer cavity 700.

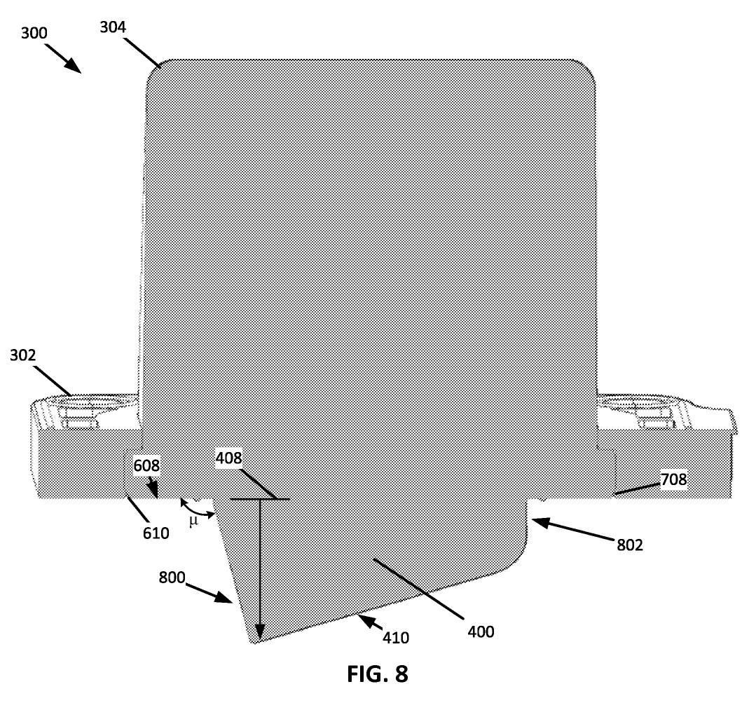

FIG. 8 shows a cross-sectional view of the reed valve 300 taken along the line VIII-VIII of FIG. 3. As shown, the cage 304 includes a plurality of notches 610 and the retainer 302 includes a plurality of retainer protrusions 708. Each retainer protrusion 708 is configured to cooperate with a corresponding notch 610 to couple the cage 304 with the retainer 302. Positioning the retainer protrusions 708 on the retainer 302 (instead of the cage 304) may encourage more efficient manufacturing. For example, when the retainer 302 and the cage 304 are formed by molding (e.g., injection molding), the number of parting lines may be reduced, which may simplify tooling, when compared to an embodiment having protrusions on the cage 304.

As further shown, the distal edge 410 of the air guide 400 extends from a first transverse edge 800 to a second transverse edge 802. The distal edge 410 extends from the maximum guide extension distance 408 at the first transverse edge 800 to the minimum guide extension distance 408 at the second transverse edge 802. The first transverse edge 800 forms an edge angle μ with the cage bottom surface 608 such that the first transverse edge 800 extends in a direction of the second transverse edge 802. The edge angle μ may be an obtuse angle.

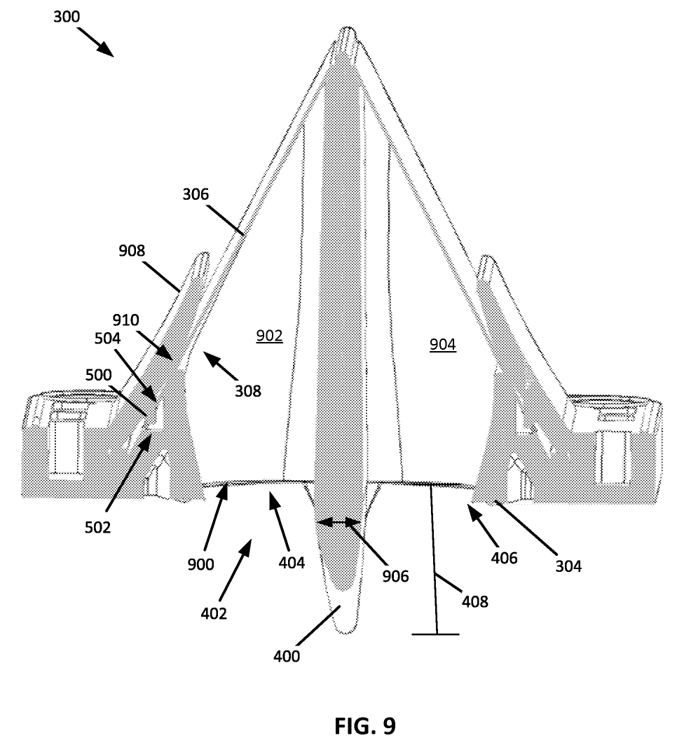

FIG. 9 shows a cross-sectional view of the reed valve 300 taken along the line IX-IX of FIG. 3. As shown, the cage 304 includes a cage cavity 900 and the inlet 402, wherein the inlet 402 defines an open end of the cage cavity 900. The cage cavity 900 fluidly couples the inlet 402 with each of the outlets 308. The air guide 400 extends within the cage cavity 900 dividing the cage cavity 900 into a first cavity portion 902 and a second cavity portion 904. The first cavity portion 902 corresponds to the first inlet portion 404 and the second cavity portion 904 corresponds to the second inlet portion 406. The first cavity portion 902 fluidly couples the first inlet portion 404 to at least one outlet 308 and the second cavity portion 904 fluidly couples the second inlet portion 406 to at least one other outlet 308. As such, in some instances, the air guide 400 may generally be described as fluidically isolating at least one outlet 308 from at least one other outlet 308 within the cage cavity 900.

A guide width 906 of the air guide 400 may increase within the cage cavity 900 in a direction of the inlet 402 and continue to increase after passing through the inlet 402 for at least portion of the guide extension distance 408. In other words, the guide width 906 may increase as the air guide 400 extends towards and out of the inlet 402. As such, the air guide 400 may generally be described as including a positive draft angle in a direction extending outwardly from the inlet 402. Such a configuration may simplify manufacturing. For example, when the cage 304 is formed by molding (e.g., injection molding), the number of parting lines may be reduced, which may simplify the tooling. In this example, the mold may be separated from the cage 304 by extracting a portion of the mold through the outlets 308 and, because the widest portion of the mold is the last to be extracted through the outlets 308, extraction of the mold does not interfere with other portions of the cage 304.

As further shown in FIG. 9, each petal tab 500 extends through a corresponding petal opening 504 of a respective reed petal 306 and into a corresponding tab receptacle 502 to capture each reed petal 306 between the cage 304 and the retainer 302. When captured, the reed petals 306 may be under an elastic deformation when the reed valve 300 is in the closed position. For example, the retainer 302 may include a plurality of reed stops 908. Each reed stop 908 can be configured to engage (e.g., contact) a corresponding reed peal 306. For example, each reed stop 908 can be configured to extend along a surface of a respective reed petal 306 and to exert a force on a respective reed petal 306 that urges the reed petal 306 towards a respective outlet 308 when the reed valve 300 is in the closed position. In this example, the reed stops 908 may include a convex (e.g., arcuate) shape having a stop apex 910 that engages (e.g., contacts) the reed petal 306 (e.g., to exert a force on the reed petal 306). The elastic deformation of the reed petals 306 may cause each of the reed petals 306 to exert a force on a corresponding sealing surface 604. Such a configuration may allow the tolerances of one or more portions of the cage 304 to be reduced as the reed petals 306 are urged into engagement with the sealing surface 604. Additionally, or alternatively, such a configuration may allow for the omission of a separate seal on the sealing surface 604 for forming a seal with a respective reed petal 306.

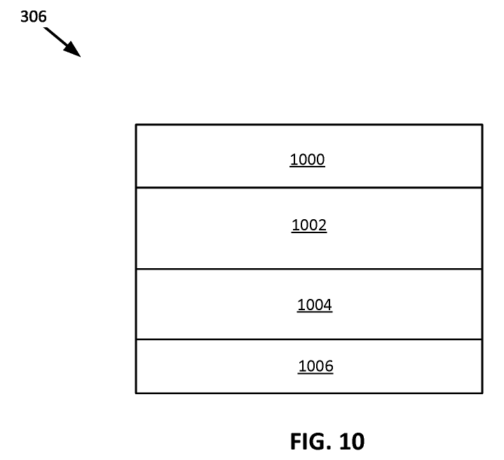

FIG. 10 shows a schematic cross-sectional view of one of the reed petals 306. As shown, each reed petal 306 includes a first layer 1000, a second layer 1002, a third layer 1004, and a fourth layer 1006, wherein the second and third layers 1002 and 1004 are disposed between the first layer 1000 and the fourth layer 1006. The fourth layer 1006 is configured to engage a corresponding sealing surface 604 (FIG. 6) of the cage body 602 (FIG. 6). The reed petal 306 may include at least one carbon fiber layer and at least one fiberglass layer, which may be bonded together with a thermoplastic resin or an epoxy resin binder. For example, the first, second, and third layers 1000, 1002, and 1004 may be carbon fiber layers and the fourth layer 1006 may be a fiberglass layer. The first, second, third, and fourth layers 1000, 1002, 1004, and 1006 may be bonded together with a thermoplastic resin or an epoxy resin binder.

Inclusion of the fiberglass layer may encourage the reed petals 306 to develop a warp, which may improve sealing between the reed petals 306 and the corresponding sealing surface 604. Additionally, or alternatively, the fiberglass layer may increase a durability and/or stiffness of the reed petal 306 (e.g., relative to a reed petal 306 having only carbon fiber layers).

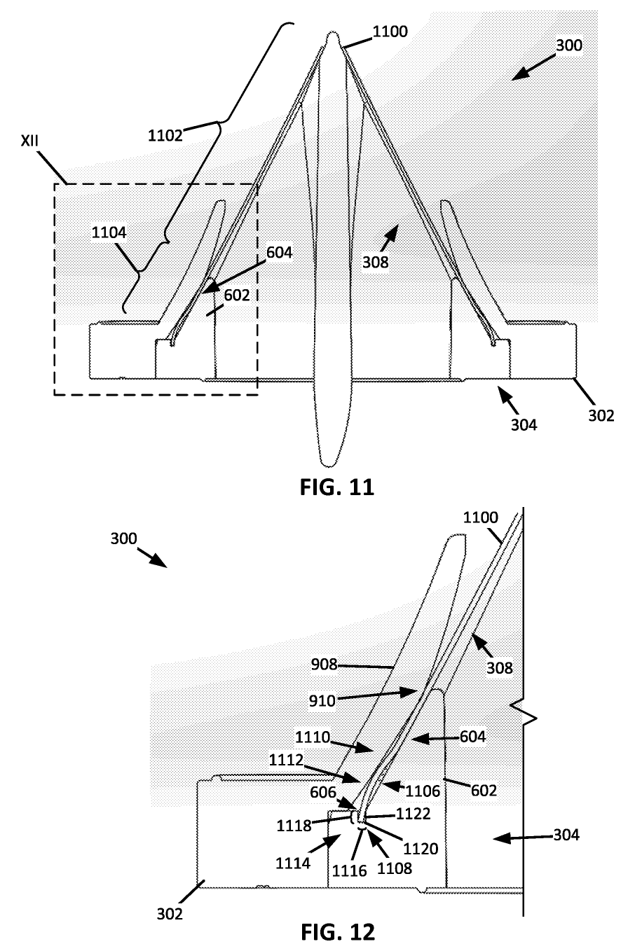

FIG. 11 shows a cross-sectional view of the reed valve 300, wherein a reed petal 1100 is captured between the retainer 302 and the cage 304. The reed petal 1100 is an example of the reed petal 306 of FIG. 3. FIG. 12 is a magnified cross-sectional view of a portion of the reed valve 300 corresponding to the region XII of FIG. 11. As shown, the reed petal 1100 includes an enclosing portion 1102 and a coupling portion 1104. The enclosing portion 1102 is configured to extend over a corresponding outlet 308 to close the corresponding outlet 308. For example, the reed petal 1100 (e.g., the enclosing portion 1102) is configured to be displaced (e.g., from a corresponding sealing surface 604 of the cage body 602) to open the outlet 308 (and transition the reed valve 300 to the open position). In this example, the enclosing portion 1102 is configured to engage (e.g., contact) the sealing surface 604 when the reed valve 300 in the closed position. As the enclosing portion 1102 is displaced, the reed petal 1100 may be elastically deformed.

The coupling portion 1104 includes one or more petal openings 504 (FIG. 5), wherein each petal opening 504 is configured to receive a corresponding petal tab 500 (FIG. 5). The coupling portion 1104 extends between at least a portion of a corresponding reed stop 908 and at least a portion of the cage body 602 of the cage 304. For example, the coupling portion 1104 may extend from a corresponding petal alignment groove 606 to the stop apex 910 of a corresponding reed stop 908. As shown, a coupling end 1114 of the reed petal 1100 is received within the petal alignment groove 606 such that movement of the coupling end 1114 within the petal alignment groove 606 is restrained (e.g., prevented).

The coupling portion 1104 includes at least one deformed (e.g., arcuate-shaped, pyramidal-shaped, etc.) region 1106 having a first region end point 1108, a second region end point 1110, and a region apex 1112 between the first and second region end points 1108 and 1110. In some instances, the cage 304 and the retainer 302 can be configured to cooperate such that a force is exerted on one or more portions of the reed petal 1100 (e.g., on the deformed region 1106). The exerted force may encourage a more consistent engagement between the enclosing portion 1102 and the cage 304 (e.g., the sealing surface 604). In other words, the reed petal 1100, the retainer 302, and the cage 304 may be generally described as being configured to cooperate to urge the reed petal 1100 (e.g., the enclosing portion 1102) towards the cage 304 (e.g., the sealing surface 604).

In some instances, the deformed region 1106 may be shaped such that the deformed region 1106 extends substantially continuously (e.g., there is less than a 10%, a 5%, a 4%, a 3%, a 2%, or a 1% change in a radius of curvature along the deformed region 1106) from the coupling end 1114. In this example, the first region end point 1108 corresponds to the coupling end 1114. As such, the first region end point 1108 may be generally described as being received within the petal alignment grove 606. The region apex 1112 can engage (e.g., contact) a portion of the reed stop 908 and is spaced apart from the cage 304 (e.g., the cage body 602). For example, the region apex 1112 can be configured to engage the reed stop 908 at a location between the stop apex 910 and the petal alignment groove 606. In this example, the region apex 1112 may engage the reed stop 908 at a location that is closer to the petal alignment groove 606 than to the stop apex 910. The second region end point 1110 can engage (e.g., contact) the cage 304 (e.g., the cage body 602) and is spaced apart from the retainer 302 (e.g., the reed stop 908). The convex shape of the reed stop 908 can be configured to decrease a separation distance extending between the reed stop 908 and the reed petal 1100 with increasing distance from the first and second region end points 1108 and 1110 such that the reed stop 908 (e.g., the stop apex 910) comes into engagement (e.g., contact) with the reed petal 1100 at the stop apex 910. As shown, both the cage 304 (e.g., the cage body 602) and the reed stop 908 (e.g., the stop apex 910) can be configured to engage (e.g., contact) the reed petal 1100 at the stop apex 910 (e.g., when the reed petal 1100 closes the outlet 308).

When the cage 304 is coupled with the retainer 302, the reed stop 908 can be configured to exert a force on the reed petal 1100 (e.g., on the deformed region 1106 that urges the region apex 1112 towards the cage body 602 of the cage 304). Such a configuration may cause the enclosing portion 1102 of the reed petal 1100 to be urged towards the sealing surface 604 of the cage body 602 (e.g., as a result of strain induced into the reed petal 1100 by the force on the deformed region 1106). In other words, the reed petal 1100 may be generally described as being configured to have a preloaded spring force that urges the enclosing portion 1102 towards the sealing surface 604.

In some instances, the deformed region 1106 may be at least partially (e.g., entirely) formed when the reed petal 1100, the cage 304, and the retainer 302 are coupled together. For example, a groove width 1116 of the petal alignment groove 606 and a groove depth 1118 of the petal alignment groove 606 may be configured such that a plane defined by the sealing surface 604 intersects a groove end wall 1120 of the petal alignment groove 606 at location between groove sidewalls 1122 of the petal alignment groove 606. In other words, the surface angle θ (FIG. 6) may be selected such that a plane that is coplanar with a substantial portion of (e.g., at least 90% of, at least 95% of, at least 96% of, at least 97% of, at least 98% of, at least 99% of, or all of) the sealing surface 604 intersects the groove end wall 1120. Such a configuration may cause the reed petal 1100 to be deformed in order to extend along and be in engagement with (e.g., contact with) the sealing surface 604. The resulting deformation may form the deformed region 1106 and cause the enclosing portion 1102 to be urged towards the sealing surface 604 of the cage body 602. Additionally, or alternatively, the deformed region 1106 may be preformed within the coupling portion 1104 of the reed petal 1100 (e.g., during manufacture).

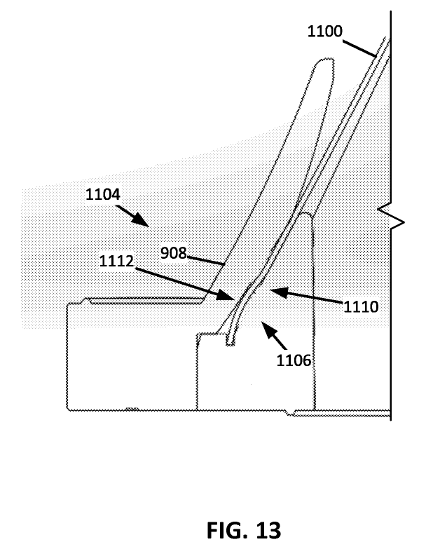

In some instances, and with reference to FIG. 13, the cage 304 can be configured to engage (e.g., contact) at least a portion of the reed petal 1100 within the deformed region 1106. Such a configuration may provide additional support to the reed petal 1100 and/or encourage the development of a predetermined shape within the coupling region 1104. Additionally, or alternatively, the convex shape of the reed stop 908 may be configured to engage (e.g., contact) the reed petal 1100 after the region apex 1112 and the second region end point 1110. Such a configuration may provide additional support to the reed petal 1100 and/or encourage the development of a predetermined shape within the coupling region 1104.

An example of a reed valve, consistent with the present disclosure, may include a retainer, a cage formed as a single-piece that is configured to be coupled to the retainer, and a first reed petal and a second reed petal, each being captured between the cage and the retainer. The cage may include an inlet, a first and a second outlet, a cage cavity fluidly coupling the inlet to the first and second outlets, and an air guide extending within the cage cavity, dividing the cage cavity into a first cavity portion fluidly coupling the inlet to the first outlet and a second cavity portion fluidly coupling the inlet to the second outlet, the air guide extends from the inlet by a guide extension distance, the air guide includes a guide width that increases within the cage cavity in a direction of the inlet. The first reed petal may selectively open and close the first outlet and the second reed petal selectively opening and closing the second outlet.

In some instances, after the air guide passes through the inlet, the guide width may continue to increase for at least a portion of the guide extension distance. In some instances, the cage may be formed as one-piece using injection molding. In some instances, the cage may include three or fewer parting lines. In some instances, the retainer may include a plurality of petal tabs and the cage includes a plurality of petal receptacles configured to cooperate with the petal tabs to capture the first and second reed petals. In some instances, the first and second reed petals may be elastically deformed when the reed valve is in a closed position. In some instances, the retainer may include a plurality of reed stops, each reed stop being configured to urge a respective one of the first or second reed petal in a direction of a corresponding one of the first or second outlet when the reed valve is in the closed position. In some instances, each of the first and second reed petals may include a carbon fiber layer and a fiberglass layer. In some instances, the carbon fiber layer may be bonded with the fiberglass layer using a thermoplastic resin binder. In some instances, the cage may further include a plurality of petal alignment grooves, each groove being configured to receive a portion of a corresponding one the first or second reed petals. In some instances, a distal edge of the air guide may be tapered such that the guide extension distance decreases from a maximum extension distance to a minimum extension distance along a length of the air guide. In some instances, the distal edge of the air guide may extend from a first transverse edge to a second transverse edge, the first transverse edge being angled to extend in a direction of the second transverse edge. In some instances, the cage may include a plurality of notches and the retainer includes a plurality of protrusions configured to cooperate with a corresponding notch of the plurality of notches to couple the cage to the retainer. In some instances, the retainer may be formed as one-piece using injection molding.

Another example of a reed valve, consistent with the present disclosure, may include, a retainer, a cage configured to be coupled to the retainer, and a reed petal captured between the cage and the retainer. The cage may include an inlet, an outlet, a cage cavity fluidly coupling the inlet to the outlet, and an air guide extending within the cage cavity, the air guide extends from the inlet by a guide extension distance. The reed petal may selectively open and close the outlet, the reed petal being elastically deformed when closing the outlet.

In some instances, the retainer may include a reed stop, the reed stop being configured to urge the reed petal in a direction of the outlet when the reed valve is in a closed position. In some instances, the reed petal may include a carbon fiber layer and a fiberglass layer. In some instances, the carbon fiber layer may be bonded with the fiberglass layer using a thermoplastic resin binder. In some instances, the cage may further include a petal alignment groove configured to receive a portion of the reed petal.

Another example of a reed valve, consistent with the present disclosure, may include a retainer, a cage coupled to the retainer, and a reed petal captured between the cage and the retainer. The cage may include an inlet, an outlet, and a cage cavity fluidly coupling the inlet to the outlet. The reed petal may be elastically deformed to selectively open and close the outlet. The reed petal may include an enclosing portion configured to extend over a corresponding outlet to close the outlet and to be displaced to open the outlet and a coupling portion including a deformed region, the retainer and the cage cooperating to exert a force on the reed petal.

In some instances, the retainer may include a petal tab and the cage may include a tab receptacle configured to cooperate with the petal tab to capture the reed petal. In some instances, the retainer may include a reed stop configured to engage the reed petal. In some instances, the reed stop may include a convex shape having a stop apex that engages the reed petal when the reed petal closes the outlet. In some instances, the deformed region may include a region apex, the region apex engaging the reed stop and being spaced apart from the cage. In some instances, the cage may further include a petal alignment groove configured to receive a portion of the reed petal. In some instances, the deformed region may include a first region end point and a second region end point, the region apex being between the first region end point and the second region end point and the first region end point being received within the petal alignment groove. In some instances, the second region end point may engage the cage and may be spaced apart from the retainer. In some instances, a separation distance between the reed stop and the reed petal may decrease with increasing distance from the second region end point such that the reed stop engages the reed petal at the stop apex. In some instances, the cage may include a plurality of notches and the retainer may include a plurality of protrusions configured to cooperate with a corresponding notch of the plurality of notches to couple the cage to the retainer.

Another example of a reed valve, consistent with the present disclosure, may include a retainer, a cage coupled to the retainer, and a reed petal captured between the cage and the retainer. The cage may include an inlet, a cage body having a sealing surface that extends around an outlet, and a cage cavity fluidly coupling the inlet to the outlet. The reed petal may be elastically deformed to selectively open and close the outlet. The reed petal may be displaced from the sealing surface to open the outlet. The reed petal, the retainer, and the cage may be configured to cooperate to urge the reed petal towards the sealing surface.

In some instances, the retainer may include a reed stop configured to engage the reed petal. In some instances, the reed stop may include a convex shape having a stop apex that engages the reed petal when the reed petal closes the outlet. In some instances, the reed petal may include an enclosing portion configured to be displaced from the sealing surface to open the outlet and a coupling portion including a deformed region. In some instances, the deformed region may include a region apex, the region apex engaging the reed stop and being spaced apart from the cage. In some instances, the cage may further include a petal alignment groove configured to receive a portion of the reed petal. In some instances, the deformed region may include a first region end point and a second region end point, the region apex being between the first region end point and the second region end point and the first region end point being received within the petal alignment groove. In some instances, the second region end point may engage the cage and be spaced apart from the retainer. In some instances, a separation distance between the reed stop and the reed petal may decrease with increasing distance from the second region end point such that the reed stop engages the reed petal. In some instances, the cage may include a plurality of notches and the retainer may include a plurality of protrusions configured to cooperate with a corresponding notch of the plurality of notches to couple the cage to the retainer.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A reed valve comprising:
a retainer;
a cage coupled to the retainer, the cage including:
an inlet;
an outlet; and
a cage cavity fluidly coupling the inlet to the outlet; and
a reed petal captured between the cage and the retainer, the reed petal being elastically deformed to selectively open and close the outlet, the reed petal including:
an enclosing portion configured to extend over a corresponding outlet to close the outlet and to be displaced to open the outlet; and
a coupling portion including a deformed region, the retainer and the cage cooperating to exert a force on the reed petal.

2. The reed valve of claim 1, wherein the retainer includes a petal tab and the cage includes a tab receptacle configured to cooperate with the petal tab to capture the reed petal.

3. The reed valve of claim 1, wherein the retainer includes a reed stop configured to engage the reed petal.

4. The reed valve of claim 3, wherein the reed stop includes a convex shape having a stop apex that engages the reed petal when the reed petal closes the outlet.

5. The reed valve of claim 4, wherein the deformed region includes a region apex, the region apex engaging the reed stop and being spaced apart from the cage.

6. The reed valve of claim 5, wherein the cage further includes a petal alignment groove configured to receive a portion of the reed petal.

7. The reed valve of claim 6, wherein the deformed region includes a first region end point and a second region end point, the region apex being between the first region end point and the second region end point and the first region end point being received within the petal alignment groove.

8. The reed valve of claim 7, wherein the second region end point engages the cage and is spaced apart from the retainer.

9. The reed valve of claim 8, wherein a separation distance between the reed stop and the reed petal decreases with increasing distance from the second region end point such that the reed stop engages the reed petal at the stop apex.

10. The reed valve of claim 1, wherein the cage includes a plurality of notches and the retainer includes a plurality of protrusions configured to cooperate with a corresponding notch of the plurality of notches to couple the cage to the retainer.

11. A reed valve comprising:
a retainer;
a cage coupled to the retainer, the cage including:
an inlet;
a cage body having a sealing surface that extends around an outlet; and
a cage cavity fluidly coupling the inlet to the outlet; and
a reed petal captured between the cage and the retainer, the reed petal being elastically deformed to selectively open and close the outlet, the reed petal being displaced from the sealing surface to open the outlet, the reed petal, the retainer, and the cage being configured to cooperate to urge the reed petal towards the sealing surface.

12. The reed valve of claim 11, wherein the retainer includes a reed stop configured to engage the reed petal.

13. The reed valve of claim 12, wherein the reed stop includes a convex shape having a stop apex that engages the reed petal when the reed petal closes the outlet.

14. The reed valve of claim 12, wherein the reed petal includes:
an enclosing portion configured to be displaced from the sealing surface to open the outlet; and
a coupling portion including a deformed region.

15. The reed valve of claim 14, wherein the deformed region includes a region apex, the region apex engaging the reed stop and being spaced apart from the cage.

16. The reed valve of claim 15, wherein the cage further includes a petal alignment groove configured to receive a portion of the reed petal.

17. The reed valve of claim 16, wherein the deformed region includes a first region end point and a second region end point, the region apex being between the first region end point and the second region end point and the first region end point being received within the petal alignment groove.

18. The reed valve of claim 17, wherein the second region end point engages the cage and is spaced apart from the retainer.

19. The reed valve of claim 18, wherein a separation distance between the reed stop and the reed petal decreases with increasing distance from the second region end point such that the reed stop engages the reed petal.

20. The reed valve of claim 11, wherein the cage includes a plurality of notches and the retainer includes a plurality of protrusions configured to cooperate with a corresponding notch of the plurality of notches to couple the cage to the retainer.
